(19) United States
(12) Patent Application Publication
(10) Pub. No.: US 2014/0055690 A1
(43) Pub. Date: Feb. 27, 2014

(54) Touch Liquid Crystal Display Device, Liquid Crystal Display Panel And Upper Substrate

(71) Applicant: BOE Technology Group Co., Ltd., Beijing (CN)

(72) Inventors: Youngsuk Song, Beijing (CN); Seungjin Choi, Beijing (CN); Seongyeol Yoo, Beijing (CN)

(73) Assignee: BOE Technology Group Co., Ltd., Beijing (CN)

(21) Appl. No.: 13/995,945

(22) PCT Filed: Feb. 17, 2013
(86) PCT No.: PCT/CN2013/071623

§ 371 Date: Jun. 19, 2013

(30) Foreign Application Priority Data
Mar. 23, 2012 (CN) 201220115308.7

(51) Int. Cl. G02F 1/1333

(52) U.S. Cl. CPC G02F 1/13338
USPC 349/12

(57) ABSTRACT

Disclosed are a touch liquid crystal display device, a liquid crystal display panel, and an upper substrate. The liquid crystal display panel comprises an upper substrate (10′) and an array substrate as a lower substrate (20′), the array substrate includes a thin film transistor (201′), a black matrix (204′), a color resin layer (205′), a pixel electrode (202′) and a spacer (30′), and the upper substrate (10′) includes a base substrate (102′), a touch sensor (101′) formed on one side of the base substrate and a common electrode (104′) formed on the other side of the base substrate. The upper substrate (10′) has a simplified structure, and therefore it is possible that production costs can be decreased, and the upper substrate can be avoided from being damages during manufacture.

### TECHNICAL FIELD

Embodiments of the present invention relate to a touch liquid crystal display device, a liquid crystal display panel and an upper substrate.

### BACKGROUND

Recently, Liquid Crystal Display (LCD) technology has been developed rapidly, and great progress has been made from screen size to display quality. LCDs have characteristics of small volume, low power consumption, no irradiation, etc., and have been playing a leading role in the field of flat panel display at present.

A touch liquid crystal display is one of important peripheral equipments, which integrates an input terminal and an output terminal. In recent years, with the emerging of a series of products such as small, light-weight handheld equipments and so on, the demand for touch liquid crystal display screens on the market increases greatly.

As shown in FIG. 1, a conventional touch liquid crystal display panel comprises an upper substrate 10 and an array substrate 20. The upper substrate 10 includes a base substrate 102, a touch sensor 101 which is formed on an outer side of the base substrate 102, and a color resin layer 103, a black matrix 104, a common electrode 105 and a spacer 30 which are formed on the other side of the base substrate 102.

The array substrate 20 of the touch liquid crystal display panel includes: a base substrate 203, and a thin film transistor 201 and a pixel electrode 202 which are formed on the base substrate 203. The thin film transistor 201 includes a gate electrode, a semiconductor layer and source and drain electrodes, the gate electrode and the semiconductor layer are separated from each other by a gate insulating layer, and a passivation layer is formed on the source and drain electrodes and the semiconductor layer.

In the above touch liquid crystal display panel, the color resin layer 103 and the black matrix 104 are formed on the upper substrate 10. In order to realize alignment of the upper substrate 10 and the array substrate 20 below, it is necessary to keep a certain process margin during manufacture of the black matrix 104, namely, it is necessary that the size of the black matrix 104 be made to be larger than size of the thin film transistor 201. This brings about relatively large impact on aperture ratio of the liquid crystal display panel.

Further, during manufacture of the upper substrate 10 of the above touch liquid crystal display panel, because the touch sensor 101 and the color resin layer 103 are formed on two sides of the base substrate 102 respectively, it is necessary to perform deposition, photolithography, etching and other procedures on each of the both sides of the base substrate 102. Whether the touch sensor 101 or the color resin layer 103 is formed earlier, when the other face is produced later, damages to the earlier formed device may not be avoided. Thus, yield of products is affected disadvantageously.

### SUMMARY

According to the embodiments of the present invention, there are provided a touch liquid crystal display device, a liquid crystal display panel and an upper substrate, therefore it is possible that damages to the upper substrate during manufacture can be avoided, and yield of products can be ensured, and moreover, the aperture ratio of products can also be increased.

In an aspect of the invention, there is provided a touch liquid crystal display panel, which comprises an upper substrate and an array substrate as a lower substrate; the array substrate includes a thin film transistor, a black matrix, a color resin layer, a pixel electrode and a spacer; the upper substrate includes a base substrate, a touch sensor formed on one side of the base substrate and a common electrode formed on the other side of the base substrate.

In another aspect of the invention, there is provided an upper substrate of a touch liquid crystal display panel, which comprises: a base substrate; a touch sensor formed on one side of the base substrate; and a common electrode formed on the other side of the base substrate, wherein on the other side of the base substrate, no black matrix and no color resin are included in the upper substrate.

For example, the upper substrate can further comprise: a buffer layer formed between the base substrate and the common electrode.

In still another aspect of the invention, there is further provided a touch liquid crystal display device, which comprises the above liquid crystal display panel.

In the embodiments of the invention, Color On Array (COA) technology is used to form the color resin layer and the black matrix on the array substrate. As such, during manufacture of the upper substrate, on only one side of a substrate are deposition, photolithography, etching and other procedures needed to be performed to form a touch sensing unit, and damages to the upper substrate which are brought by performing deposition, photolithography, etching and other procedures on two sides of a base substrate in a conventional technology can be avoided. As the structure of the upper substrate is simplified, yield of touch liquid crystal display panels is ensured, and their production costs are also reduced.

Because the black matrix is formed on the array substrate, it is unnecessary that a process margin be retained during manufacture of the black matrix, and the size of the black matrix can be made substantially the same as the size of the thin film transistor as well as a gate line and a data line. In such a manner, the aperture ratio of the liquid crystal display panel can be increased.

### BRIEF DESCRIPTION OF THE DRAWINGS

In order to illustrate the technical solution of the embodiments of the invention more clearly, the drawings of the embodiments will be briefly described below; it is obvious that the drawings as described below are only related to some embodiments of the invention, but not limitative of the invention.

FIG. 1 is a structurally schematic view showing a conventional liquid crystal display panel; and

FIG. 2 is a structurally schematic view showing a liquid crystal display panel according to an embodiment of the invention.

### DETAILED DESCRIPTION

In order to make objects, technical details and advantages of the embodiments of the invention apparent, hereinafter, the technical solutions of the embodiments of the invention will be described in a clearly and fully understandable way in connection with the drawings related to the embodiments of the invention. It is obvious that the described embodiments are just a part but not all of the embodiments of the invention. Based on the described embodiments of the invention, those ordinarily skilled in the art can obtain other embodiment(s), without any inventive work, which should be within the scope sought for protection by the invention.

Unless otherwise defined, the technical terminology or scientific terminology used herein should have the same meaning as commonly understood by one of ordinary skill in the art to which this invention belongs. “First”, “second” and the like used in specification and claims of the patent application of the invention do not show any order, number or importance, but are only used to distinguish different constituent parts. Likewise, a term “a,” “an,” “the” or the like does not indicate limitation in number, but specifies the presence of at least one. Phrases such as “comprises,” “comprising,” “includes,” “including”, “contains” or the like means that an element or article ahead of this term encompasses element(s) or article(s) listed behind this term and its(their) equivalents, but does not preclude the presence of other elements or articles. Phrases such as “connection,” “connected,” or the like is not limited to physical or mechanical connection, but can include electrical connection, whether directly or indirectly. “Upper,” “lower,” “left,” “right” or the like is only used to describe a relative positional relationship, and when an absolute position of the described object is changed, the relative positional relationship might also be changed accordingly.

FIG. 2 is a cross-sectional view showing one sub-pixel of a touch liquid crystal display panel according to an embodiment of the invention. Sub-pixels constitute one pixel; for example, one pixel may include red, green and blue (RGB) sub-pixels, or in addition to the RGB sub-pixels, it may further include a white (W) sub-pixel.

As shown in FIG. 2, the touch liquid crystal display panel according to the embodiment of the invention may include: an upper substrate 10′, a lower substrate 20′ and a liquid crystal layer 40′ provided between the upper substrate 10′ and the lower substrate 20′. The upper substrate 10′ does not include a black matrix and a color resin layer.

The upper substrate 10′ includes: a base substrate 102′; a touch sensor 101′ formed on an outer side of the base substrate 102′; a buffer layer 103′ formed on the other side of the base substrate 102′; and a common electrode 104′ formed on the buffer layer 103′.

The base substrate 102′ may adopt a kind of glass of soda-lime borosilicate, and may also adopt hard-wearing, strengthened glass, and additionally, it may adopt a plastic base material. A transparent conductive material such as Indium Tin Oxide (ITO), Indium Zinc Oxide (IZO) or the like can be used to form the common electrode 104′.

An insulating material such as SiNx, an organic resin or the like can be used to form the buffer layer 103′, which is optional. The color-filter resin layer is produced on the lower substrate, so the upper substrate can adopt plastic as a base material, and a buffer layer is formed between the plastic base material and the common electrode. This allows the common electrode to be attached to the base material better. When the upper substrate adopts glass as the base material, the buffer layer 103′ may not be formed.

The touch sensor 101′ may be a touch sensor of any suitable type in the related field, such as, a capacitive type, a resistive type, an infrared type, a surface acoustic wave type, etc. The invention is not limited to the specific type and structure of the touch sensor 101′. Each of touch sensing units can correspond to one pixel on an array substrate, or may correspond to two or more pixels on the array substrate.

The lower substrate 20′ is an array substrate and includes: a base substrate 203′; a gate electrode and a gate line which are formed on the base substrate 203′; a gate insulating layer formed on the gate electrode; a semiconductor layer formed on the gate insulating layer; and a source electrode, a drain electrode and a data line which are formed on the semiconductor layer. Preferably, for the purpose of improving characteristics of a thin film transistor, an ohmic contact layer (not shown in the figure) can be provided between the source and drain electrodes and the semiconductor layer so as to reduce contact resistances between the source and drain electrodes and the semiconductor layer. The gate electrode, the gate insulating layer, the semiconductor layer, the source electrode and the drain electrode together constitute a thin film transistor 201′, as shown in FIG. 2. The thin film transistor 201′ shown in the figure is of a bottom-gate type, or the thin film transistor 201′ may be of a top-gate type or of other type. The invention is not limited to the specific type of the thin film transistor 201′.

The lower substrate 20′ may further include: a passivation layer 210′ formed on the thin film transistor 201′; a black matrix 204′ formed on the passivation layer 210′ in a region where the thin film transistor 201′ is provided; a color resin layer 205′ formed on the passivation layer 210′ and the black matrix 204′; a pixel electrode 202′, which is formed on the color resin layer 205′ and electrically connected to a drain electrode of the thin film transistor 201′ through a contact hole 206′; and a spacer 30′ formed over the region in correspondence with the TFT; the size of the black matrix 204′ can be the same as or slightly larger than the size of the thin film transistor 201′. The spacer 30′ may be in a columnar shape, and may also be in other shape, such as a spherical shape, and it serves to maintain the space between the upper substrate 10′ and the lower substrate 20′.

For example, the thickness of the black matrix 204′ may be in the range of 0.5-2 μm, its sheet resistance may be 1012Ω/cm²; the thickness of the color resin layer 205′ may be in the range of 1-4 μm, and its dielectric constant may be in the range of 3-5.

The base substrate 203′ may adopt a kind of glass of soda-lime borosilicate, and may also adopt hard-wearing, strengthened glass, and additionally, it may adopt a plastic base material. A transparent conductive material such as Indium Tin Oxide (ITO), Indium Zinc Oxide (IZO) or the like can be used to form the pixel electrode 202′.

In addition, around sub-pixels (such as, red, green and blue (RGB) sub-pixels) and around a display area of the panel, there are also formed black matrices, and moreover, the size of the black matrix surrounding the sub-pixels can be the same as the size of the gate lines and the data lines. The gate lines and the data lines are formed on the base substrate 203′, and, for example, intersect each other to define sub-pixel regions.

Depending on the color to be displayed by a sub-pixel, the color resin layer 205′ may be for example a red, green or blue resin layer, or may be a white resin layer, and a known material in the related field can be used to form the color resin layer 205′.

In the above liquid crystal display panel according to the embodiment of the invention, Color On Array (COA) technology is used to form the color resin layer and the black matrix on the array substrate. As such, during manufacture of the upper substrate 10′, on only one side of the base substrate 102′ are deposition, photolithography, etching and other procedures needed to be performed to form a touch sensing unit of the touch sensor 101′, and damages to the upper substrate which is brought in performing deposition, photolithography, etching and other procedures on two sides of a base substrate in the conventional technology can be avoided. As the structure of the upper substrate 10′ is simplified, its production costs are also reduced.

Further, because the black matrix 204′ is formed directly on the array substrate 20′, it is unnecessary any more that a black matrix produced on a color filter substrate be widened for retaining of a process margin necessary for cell-assembling of the upper and lower substrates. Thus, the size of the black matrix only has to be made to be substantially the same as the size of the thin film transistor. In such a manner, the aperture ratio of the liquid crystal display panel can be increased.

According to an embodiment of the invention, there is further provided a touch liquid crystal display device, which comprises a driving capacitor, a display frame and the above touch liquid crystal display panel. It is possible that a backlight source is provided behind the display panel, and the backlight source may adopt light emitting diodes, a code cathode fluorescent lamp or the like as the light source.

In an example, the lower substrate of the touch liquid crystal display panel according to the embodiment of the invention can be produced by the following procedure. In the touch liquid crystal display panel, red, green and blue (RGB) sub-pixels constitute one pixel.

Step 1, a layer of a conductive metal is deposited on a glass substrate which is prepared in advance, and then the gate electrode and the gate line are formed through a first masking process.

Mo, Al, Ti, Cu or other material may be used as the conductive metal.

Step 2, a gate insulating layer and a semiconductor layer are continually deposited on the base substrate subjected to the step 1.

The gate insulating layer may adopt SiNx, SiOx or other material, and the semiconductor layer may adopt a-Si or other material.

Step 3, a layer of a source and drain metal film is deposited on the base substrate subjected to the step 2.

Step 4, the source electrode, the drain electrode and the semiconductor layer of the thin film transistor are formed on the base substrate subjected to the step 3 with a grey-tone or half-tone mask plate with a second patterning process;

Further, an ohmic contact layer in correspondence with a channel region is removed through an etching process, so as to form the channel of the thin film transistor.

Step 5, a passivation layer is formed on the base substrate subjected to the step 4 so as to protect the thin film transistor as well as the gate line and the data line. The passivation layer may be formed by means of depositing SiNx or other inorganic material, and it may also be formed with a transparent, organic resin material.

Step 6, on the base substrate subjected to the step 5, black matrices are formed in a place corresponding to the thin film transistors, around sub-pixels and around the display area of the panel with a third patterning process.

Surroundings of the sub-pixels are periphery of the sub-pixel regions defined by intersecting of the gate lines and data lines, the sizes of the black matrices may be the same as sizes of the thin film transistors, the gate lines and the data lines. An opaque, resin material, chromium oxide or other material may be used as the material of the black matrices, for the purpose to prevent occurrence of a light-leakage phenomenon due to transmission of light from the backlight source through the area of the thin film transistors, around sub-pixels and around the panel display.

Step 7, on the base substrate subjected to the step 6, with a fourth patterning process, a fifth patterning process and a sixth patterning process in sequence, a red resin layer, a green resin layer and a blue resin layer are formed on the sub-pixel regions so as to form a red sub-pixel region (R), a green sub-pixel region (G) and a blue sub-pixel region (B). Each of the red, green and blue (RGB) sub-pixels includes a thin film transistor functioning as a switch element, and each group of RGB sub-pixels constitutes one pixel. Or, for example, each pixel can further include a white (W) sub-pixel, namely, it adopts a combination of RGB W, and then, one more patterning process will be used accordingly to form a white resin layer.

Up to here, the manufacture of color-filter resin layers on the array substrate is completed, and subsequently, the via hole and the pixel electrode on the array substrate will be formed.

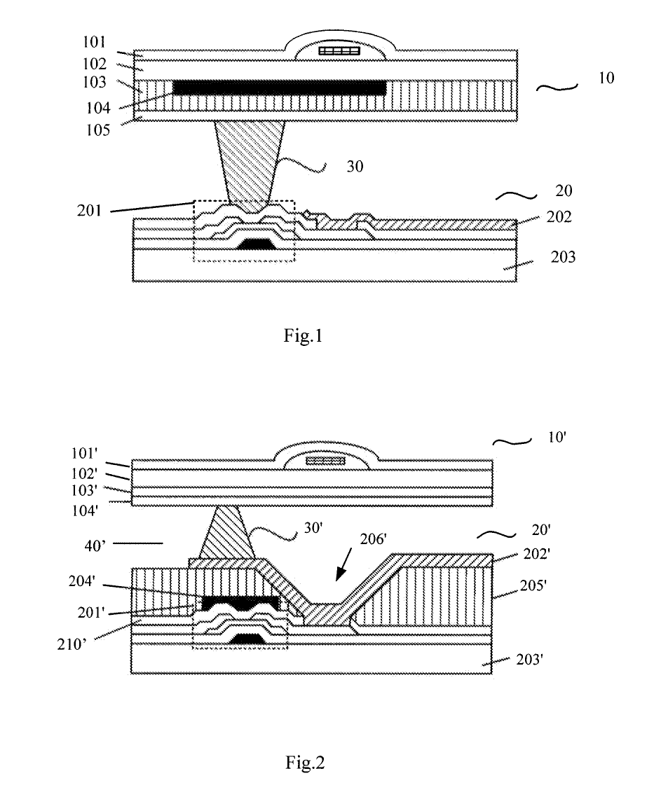

Because the black matrices as well as the color resin layers are directly produced on the array substrate through a patterning process and correspond to the thin film transistors, the gate lines and the data lines on a one-to-one basis, no more process redundancies is no longer required for alignment of the color filter substrate and the array substrate. So, the line width of the black matrices can be decreased significantly. As compared to the conventional technology as shown in FIG. 1, aperture ratio can be increased.

Step 8, with a seventh patterning process, a contact via hole is formed on the color-filter resin layers on the array substrate; the position of the via hole corresponds to a drain region so as to allow the drain electrode of the thin film transistor to be exposed, and electric connection between the pixel electrode and the drain electrode can be achieved through the via hole. In this procedure, the color-filter resin layers and the passivation layer need to be etched consecutively so as to remove the passivation layer and the color resin layers which are located on the drain electrode and in correspondence with the location of the via hole.

Step 9, on the base substrate subjected to the step 10, the pixel electrode is formed with a eighth patterning process. A transparent conductive material such as ITO, IZO or the like can be used as the material for the pixel electrode. The electric connection of the pixel electrode to the drain electrode is achieved through the contact hole.

Step 10, the spacer is provided on the base substrate subjected to the step 9. The shape of the spacer may be in a columnar shape, a spherical shape or other shape. If ball-shaped spacers are used, then the structure can be achieved by spraying ball-shaped spacers on the substrate upon cell-assembling.

Up to here, the manufacture of the array substrate of the touch liquid crystal display panel is completed. A COA technology is used to produce color filters and black matrices on the array substrate, and then the selective scope for a base material of the upper substrate may not need to be limited. A glass substrate may be used as the base substrate, or a plastic material may be used as the base substrate.

The resultant thin film transistor in the above example is of a bottom-gate type; and if the used thin film transistor is of a top-gate type, then the above forming steps can be adjusted accordingly. These steps may be performed in accordance with those in the conventional technology, and details are omitted here for simplicity.

For example, the upper substrate of the touch liquid crystal display panel according to the invention can be fabricated by the following procedure.

Step 21, the touch sensing unit is formed on one side (an outer side) of a prepared substrate with a patterning process, and its forming process may be the same as those in the conventional technology, details being omitted here.

Step 22, the buffer layer is formed on the other side of the base substrate with the touch sensing unit formed thereon.

SiNx, an organic resin, or other insulating material may be used to form the buffer layer. Where a plastic material is used for the base substrate, the buffer layer can allow a subsequent material for the common electrode to be well attached to the base material. Where a glass material is used for the base substrate, it is also possible that no buffer layer is formed.

Step 23, on the base substrate subjected to the step 22, a transparent, conductive material is deposited so as to form the common electrode of the upper substrate.

Up to here, the exemplary manufacture of the upper substrate of the touch liquid crystal display panel is completed.

As stated above, when the upper substrate is a glass substrate and of the same material as the lower substrate, the manufacture of the buffer layer can be omitted, and the common electrode is formed directly on the other side with respect to the touch sensing unit.

Because the manufacturing procedure of the upper substrate has already been very simple and easy, forming the touch sensing unit and the common electrode on two sides of the upper substrate, respectively, may not be limited by the manufacturing sequence. That is, it is possible that the touch sensing unit is produced first, and then the buffer layer and the common electrode are produced later on the other side; and it is also possible that the buffer layer and the common electrode are produced first, and then the touch sensing unit is produced later on the other side.

According to the embodiment of the invention, the color-filter resin layers and the black matrices are produced on the array substrate by a COA technology, and thus, manufacturing process of the upper substrate is simple and easy. It is not necessary to perform exposure, development, etching, stripping of photoresist and other complicated processes in the patterning process on the side of the upper substrate where the common electrode is produced; therefore it is can be avoided that exposure, development, etching, stripping of photoresist and other complicated procedures need to performed on both sides of an upper substrate in a conventional process and thus a device first formed on one side is damaged. Thereby, yield of manufacturing touch liquid crystal display panels is ensured.

The foregoing are merely exemplary embodiments of the invention, but are not used to limit the protection scope of the invention. The protection scope of the invention is defined by attached claims.

1. A touch liquid crystal display panel, comprising an upper substrate and an array substrate as a lower substrate, wherein
the array substrate includes a thin film transistor, a black matrix, a color resin layer, a pixel electrode and a spacer; and
the upper substrate includes a base substrate, a touch sensing unit formed on one side of the base substrate and a common electrode formed on the other side of the base substrate.

2. The touch liquid crystal display panel of claim 1, wherein the upper substrate further includes a buffer layer formed between the base substrate and the common electrode.

3. The touch liquid crystal display panel of claim 2, wherein a material for the buffer layer is SiNx.

4. The touch liquid crystal display panel of claim 1, wherein a material for the base substrate of the upper substrate is plastic or glass.

5. The touch liquid crystal display panel of claim 1, wherein a size of the black matrix is the same as sizes of the thin film transistor, a gate line and a data line.

6. The touch liquid crystal display panel of claim 1, wherein a thickness of the color resin layer is in the range of 1-4 μm.

7. The touch liquid crystal display panel of claim 1, wherein the spacer is a ball-shaped spacer or a column-shaped spacer.

8. An upper substrate of a touch liquid crystal display panel, comprising:
a base substrate;
a touch sensor formed on one side of the base substrate; and
a common electrode formed on the other side of the base substrate, wherein on the other side of the base substrate, no black matrix and no color resin are included in the upper substrate.

9. The upper substrate of claim 8, further comprising a buffer layer, formed between the base substrate and the common electrode.

10. A touch liquid crystal display device, comprising the touch liquid crystal display panel of claim 1.
